(19) United States
(12) Patent Application Publication
(10) Pub. No.: US 2025/0109771 A1
(43) Pub. Date: Apr. 3, 2025

(54) PARKING BRAKE

(71) Applicant: HL MANDO CORPORATION, Pyeongtaek (KR)

(72) Inventors: Hatem SHAHIN, Pfaffenhofen (DE); Kai BRAUN, Friedrichsdorf (DE)

(21) Appl. No.: 18/611,749

(22) Filed: Mar. 21, 2024

(30) Foreign Application Priority Data
Sep. 28, 2023 (DE) 102023209569.6

(51) Int. Cl. F16D 49/16; F16D 65/06; F16D 125/58

(52) U.S. Cl. CPC F16D 49/16; F16D 65/06; F16D 2125/587

(57) ABSTRACT

A parking brake according to an embodiment of the present disclosure includes a disk configured to rotate with a wheel of a vehicle, a carrier having a rotational shaft formed at one side, configured to advance and retract by an actuator toward an outer circumferential surface of the disk, and a friction pad coupled to the carrier to be rotatable about the rotational shaft, configured to pressurize or depressurize at least a portion of the outer circumferential surface of the disk in response to reciprocating motion of the carrier.

### CROSS-REFERENCE TO RELATED APPLICATION

This application claims the benefit of German Patent Application No. 102023209569.6, filed on Sep. 28, 2023 in the German Patent Office (DPMA), the disclosures of which are incorporated herein by reference in its entirety.

### BACKGROUND

### 1. Field

Embodiments of the present disclosure relate to a parking brake, and more particularly to a parking brake that provides braking force to prevent movement of a parked vehicle by pressing a disk rotating with a wheel of the vehicle in a radial direction.

### 2. Description of the Related Art

In general, parking brakes applied to vehicles can be classified into DIH (Drum In Hat) type and PIC (Parking Integrated Caliper) type. In recent years, the PIC type of parking brake, which has advantages in cost and weight compared to the DIH type of parking brake, has been widely applied from small cars to medium and large cars, and this trend is expected to continue.

These PIC-type parking brakes operate the same as conventional floating-type caliper brakes during normal braking with the brake pedal, but are provided with a mechanical structure inside the caliper that can perform parking brake functions, such as cable operation.

The problem with these conventional PIC-type parking brakes is that when the parking brake is applied while the disk is thermally expanded after repeated braking with the main brake, the initially intended parking braking performance decreases as a gap between the disk and the friction material occurs when the disk cools over time.

To solve this problem, a PIC type parking brake with a friction material with a relatively high coefficient of friction was developed, but the parking brake with such a relatively high friction material has a limitation that it cannot be a fundamental solution because it causes another problem such as increased brake noise.

On the other hand, to solve this problem, a PIC-type parking brake that can compensate for the gap between the disk and the friction material due to thermal expansion of the disk has been developed, but it is difficult to compensate for the gap between the friction material and the disk by considering various factors, including thermal expansion of the disk and wear of the friction material due to brake operation.

### SUMMARY

Therefore, it is an aspect of the present disclosure to provide a parking brake that generates a braking force by pressing the outer circumferential surface of the disk in a radial direction separately from the main brake, to prevent the performance of the parking brake from deteriorating due to thermal expansion of the disk, etc.

It is another aspect of the present disclosure to provide a parking brake in which a friction pad made of a relatively strong material presses the outer circumferential surface of the disk in a radial direction to generate a braking force, thereby minimizing the deterioration of the braking performance due to wear or deformation of the friction pad due to brake operation.

In accordance with an aspect of the present disclosure, a parking brake may be provided, including a disk configured to rotate with a wheel of a vehicle, a carrier having a rotational shaft formed at one side, configured to advance and retract by an actuator toward an outer circumferential surface of the disk, and a friction pad coupled to the carrier to be rotatable about the rotational shaft, configured to pressurize or depressurize at least a portion of the outer circumferential surface of the disk in response to reciprocating motion of the carrier.

The friction pad may include a pad plate having a hinge portion rotatably engaged with the rotational shaft and a friction surface arranged between the pad plate and the outer circumferential surface of the disk.

The friction surface may be arranged in an arc shape having a curvature equal to a curvature of the disk.

The rotational shaft may be arranged parallel to a rotational axis of the disk.

The parking brake may further include an elastic member between the carrier and the friction pad, configured to provide an elastic force to allow the friction pad to be rotated about the rotational shaft.

The elastic member may be coupled to the carrier at one end and to the friction pad at the other end to rotate the friction pad to a predetermined angle about the rotational shaft when the carrier is spaced from the disk.

The rotation angle of the friction pad rotating about the rotational shaft by the elastic member may be limited by a jamming portion arranged on the carrier and a support portion arranged on the friction pad.

The friction pad may further include a rounding portion arranged at an end where the carrier is moved toward the outer circumferential surface of the disk and makes first contact with the outer circumferential surface of the disk.

In accordance with another aspect of the present disclosure, a parking brake may be provided, including a disk configured to rotate with a wheel of a vehicle, a pair of carriers each having a rotational shaft arranged on one side and disposed on both sides of an outer circumferential surface of the disk relative to a rotational axis of the disk, configured to advance and retract by an actuator toward the outer circumferential surface of the disk, and a pair of friction pads each coupled to the carrier to be rotatable about the rotational shaft, configured to pressurize or depressurize at least a portion of the outer circumferential surface of the disk in response to reciprocating motion of the carrier.

The friction pad may include a pad plate having a hinge portion rotatably engaged with the rotational shaft and a friction surface arranged between the pad plate and the outer circumferential surface of the disk.

The friction surface may be arranged in an arc shape having a curvature equal to a curvature of the disk.

The rotational shaft may be arranged parallel to a rotational axis of the disk.

The carriers may be arranged to be spaced from each other relative to a rotational axis of the disk by the actuator.

The carriers may be arranged to be advanced and retracted by the actuator independently of each other toward the outer circumferential surface of the disk.

In accordance with still another aspect of the present disclosure, a parking brake may be provided, including a disk configured to rotate with a wheel of a vehicle, a carrier having a rotational shaft arranged on each side of the carrier, configured to advance and retract by an actuator toward an outer circumferential surface of the disk, and a pair of friction pads each coupled to both sides of the carrier to be rotatable about each rotational shaft, configured to pressurize or depressurize at least a portion of the outer circumferential surface of the disk in response to reciprocating motion of the carrier.

A center between the rotational shafts may be arranged on a straight line equal to a center of a rotational axis of the disk.

The friction pad may include a pad plate having a hinge portion rotatably engaged with the rotational shaft and a friction surface arranged between the pad plate and the outer circumferential surface of the disk.

The friction surface may be arranged in an arc shape having a curvature equal to a curvature of the disk.

The rotational shaft may be arranged parallel to a rotational axis of the disk.

The friction pad may further include a rounding portion arranged at an end where the carrier is moved toward the outer circumferential surface of the disk and makes first contact with the outer circumferential surface of the disk.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a side view illustrating an engaged and disengaged state of a parking brake according to an embodiment of the present disclosure;

FIG. 2 is a side view illustrating a disengaged state of a parking brake according to an embodiment of the present disclosure;

FIG. 3 is a side view illustrating the engaged state of a parking brake according to an embodiment of the present disclosure;

FIG. 4 is a side view illustrating the disengaged state of a parking brake according to another embodiment of the present disclosure;

FIG. 5 is a side view illustrating the engaged state of the parking brake according to FIG. 4;

FIG. 6 is a side view illustrating the disengaged state of a parking brake according to another embodiment of the present disclosure; and

FIG. 7 is a side view illustrating the engaged state of the parking brake according to FIG. 6.

### DETAILED DESCRIPTION

Hereinafter, embodiments of the present invention will be described in detail with reference to the accompanying drawings. The following embodiments are presented to sufficiently convey the ideas of the present invention to those skilled in the art to which the present invention belongs. The invention is not limited to the embodiments shown herein and may be embodied in other forms. To clarify the invention, the drawings may omit drawings that are not pertinent to the description, and the sizes of components may be somewhat exaggerated for ease of understanding.

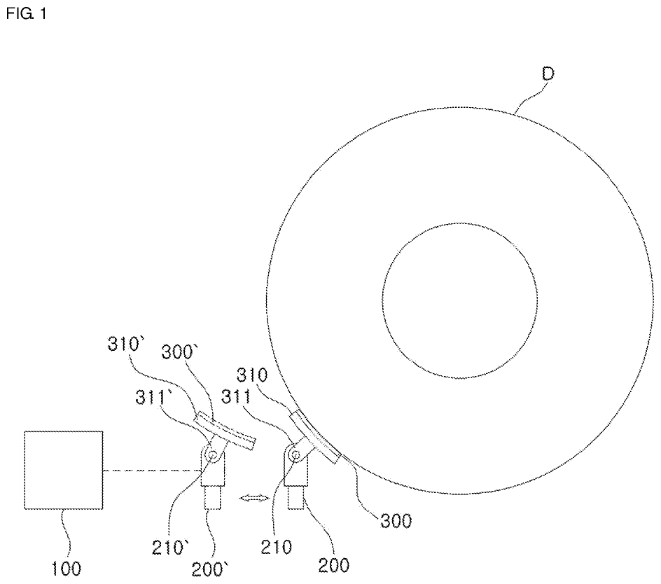

FIG. 1 is a side view illustrating an engaged and disengaged state of a parking brake according to an embodiment of the present disclosure.

Referring to FIG. 1, a parking brake according to an embodiment of the present disclosure includes an actuator 100, a carrier 200 and a friction pad 300.

The actuator 100 serves as a means to advance and retract the carrier 200 toward the disk D that rotates with a vehicle's wheel, and both an electromechanical method utilizing an electric motor and a hydraulic method utilizing fluid pressure can be applied. For example, the actuator may include an electric motor or a hydraulic piston.

More specifically, if the actuator 100 is arranged in an electromechanical manner, the actuator 100 may further include an electric motor and a power transmission means, such as gears for converting the rotational motion output therefrom into a reciprocating motion of the carrier 200. Further, if the actuator 100 is arranged in a hydraulic manner, the carrier 200 may be integrally arranged with a piston that is hydraulically reciprocated from a cylinder so that the actuator 100 and the carrier 200 are integrally arranged.

Additionally, although not shown, the actuator 100 may be arranged to share some components with an actuator of a brake system that performs normal braking of a vehicle in which the parking brake of an embodiment of the present disclosure is installed. For example, the actuator 100 may be arranged to selectively receive rotational force from an electric motor comprising an actuator of a brake system performing normal braking of a vehicle, by means of a clutch or other configuration.

The carrier 200 may include a rotational shaft 210 arranged on one side, and may be advanced and retracted by the actuator 100, as described above, toward the disk D that rotates with the wheel of the vehicle. Here, the rotational shaft 210 may be arranged parallel to a rotational axis of the disk D.

Meanwhile, the carrier 200 may be installed with the actuator 100 on a housing or base or the like for guiding the reciprocating motion of the carrier 200, although not shown. In this case, the carrier 200 may be installed with the actuator 100 on the housing of the brake system that performs normal braking of the vehicle in which the parking brake of an embodiment of the present disclosure is installed.

Furthermore, when the carrier 200 advances and retracts toward the disk D, the direction of movement may be formed from a forward or rearward side of the disk D to a rearward or forward side of the disk D, or from a downward or upward side of the disk D to an upward or downward side. Additionally, the carrier 200 may be formed such that when it is advanced and retracted toward the disk D, the direction of movement is facing the rotational axis of the disk D.

The friction pad 300 may be coupled to the carrier 200 to be rotatable about the rotational shaft 210 to pressurize or depressurize at least a portion of an outer circumferential surface of the disk D in response to the reciprocating motion of the carrier 200. To achieve this, the friction pad 300 may include a pad plate 310 having a hinge portion 311 rotatably engaged with the rotational shaft 210.

Furthermore, the friction pad 300 may be provided with a relatively higher stiffness material compared to the friction pad of a brake system performing normal braking of a vehicle in which the parking brake of an embodiment of the present disclosure is installed. This is because the friction pad 300 of the parking brake of an embodiment of the present disclosure may be subject to relatively less noise and dust generated by friction between the disk and the friction pad during braking compared to the friction pad of a brake system performing normal braking of a vehicle. For example, the friction pad 300 may be made of the same metal material as the disk D, such as steel.

The parking brake according to an embodiment of the present disclosure configured as described above can maintain the vehicle in a parked state by a braking force generated by the friction pad 300 that is rotatable from the carrier 200 that is advanced and retracted by the actuator 100 independently of a brake system that performs normal braking.

Accordingly, the parking brake according to an embodiment of the present disclosure can improve the operational reliability of the parking brake by minimizing braking performance degradation due to frequent brake operation during operation and temperature changes caused by an external environment, etc. compared to a conventional PIC type parking brake.

In particular, the parking brake of the present embodiment can further improve the operational reliability of the parking brake by minimizing the deterioration of the braking performance due to wear or deformation of the friction pad, as described above, as the friction pad, which is provided with a relatively strong material, presses the outer circumferential surface of the disk in a radial direction to generate a braking force.

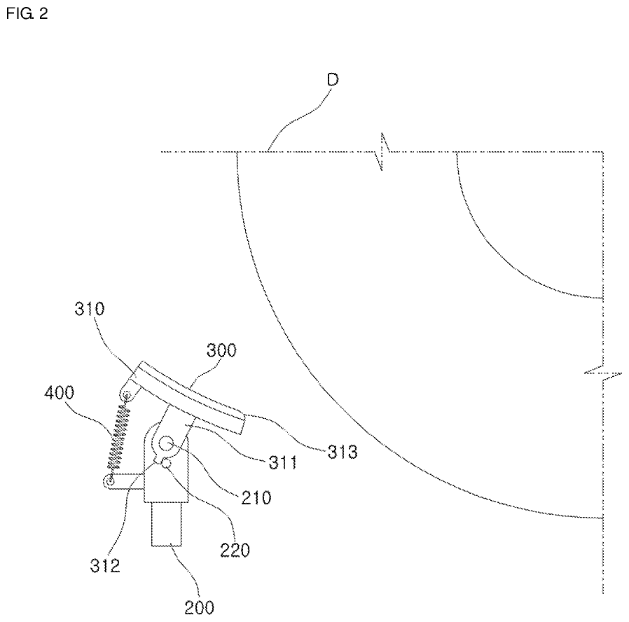

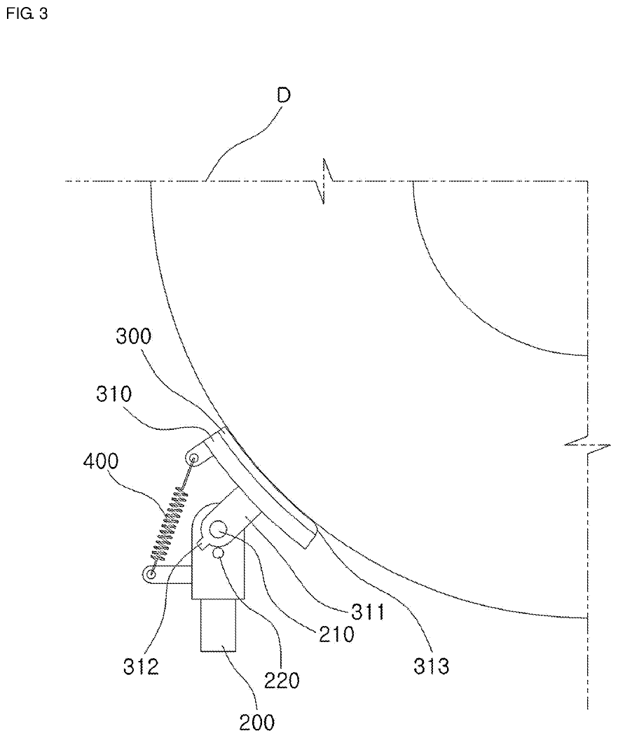

FIG. 2 is a side view illustrating a disengaged state of a parking brake according to an embodiment of the present disclosure, and FIG. 3 is a side view illustrating the engaged state of a parking brake according to an embodiment of the present disclosure.

Referring to FIGS. 2 and 3, a parking brake according to an embodiment of the present disclosure may further include an elastic member 400 that provides elastic force to the friction pad 300 from the carrier 200, and an over-rotation prevention structure that limits the rotation angle of the friction pad 300 about the rotational shaft 210.

More specifically, the elastic member 400 is fixed to the carrier 200 at one end, and the other end is fixed to one side of the friction pad 300 to provide an elastic force to allow the friction pad 300 to be rotated about the rotational shaft 210. Accordingly, the parking brake according to an embodiment of the present disclosure can maintain the friction pad 300 in a state in which the friction pad 300 is rotated to a certain angle counterclockwise about the rotational shaft 210 by the elastic member 400 when the parking brake is in a disengaged state, that is, when the vehicle is traveling or when the general brake system is in operation, as shown in FIG. 2. Furthermore, although the elastic member 400 is illustrated as a coil spring, it is understood that it may include a variety of other elastic members known in the art.

On the other hand, in the over-rotation prevention structure, a support portion 312 arranged on the friction pad 300 may be supported on the jamming portion 200 arranged on the carrier 200 such that the friction pad 300 is prevented from rotating beyond a predetermined angle by the elastic member 400 around the rotational shaft 210. Of course, such an over-rotation prevention structure can be applied to various structures known in the art in addition to the above structure.

The parking brake according to an embodiment of the present disclosure is illustrated in FIG. 3, wherein the carrier 200 is moved by the actuator 100 toward the disk D for entry into the engaged state of the parking brake, and the bottom side of the friction pad 300 contacts the outer circumferential surface of the disk D, continued movement of the carrier 200 may cause the friction pad 300 to rotate about the rotational shaft 210 such that one side of the friction pad 300 contacts at least a portion of the outer peripheral surface of the disk D, thereby preventing the disk D from rotating.

At this time, to prevent damage to the bottom side of the friction pad 300 or the outer circumferential surface of the disk D due to collision between the bottom side of the friction pad 300 and the outer circumferential surface of the disk D as the carrier 200 moves toward the disk D, the friction pad 300 may further include a rounded portion 313 arranged on the bottom side.

Furthermore, the elastic member 400 is maintained in a tensile state in the engaged state of the parking brake compared to the disengaged state of the parking brake, and the rotation angle of the friction pad 300 may be limited by one side of the friction pad 300 being in close contact with the outer circumferential surface of the disk D. To achieve this, the friction pad 300 may be formed such that the curvature of the braking surface pressurizing or depressurizing a portion of the outer circumferential surface of the disk D is the same as the curvature of the disk D.

Accordingly, the parking brake of an embodiment of the present disclosure can maintain a stationary state of the disk D by causing the friction pad 300 to pressurize a side of the outer circumferential surface of the disk D in a radial direction by the carrier 200. In particular, as a portion of the friction pad 300 may wear out due to frequent use of the friction pad 300, and as the friction pad 300 may rotate from the rotational shaft 210 and be in close contact with the outer circumferential surface of the disk D even in a state of different curvature from the outer circumferential surface of the disk D, the braking performance may be further prevented from deteriorating due to wear or deformation of the friction pad 300.

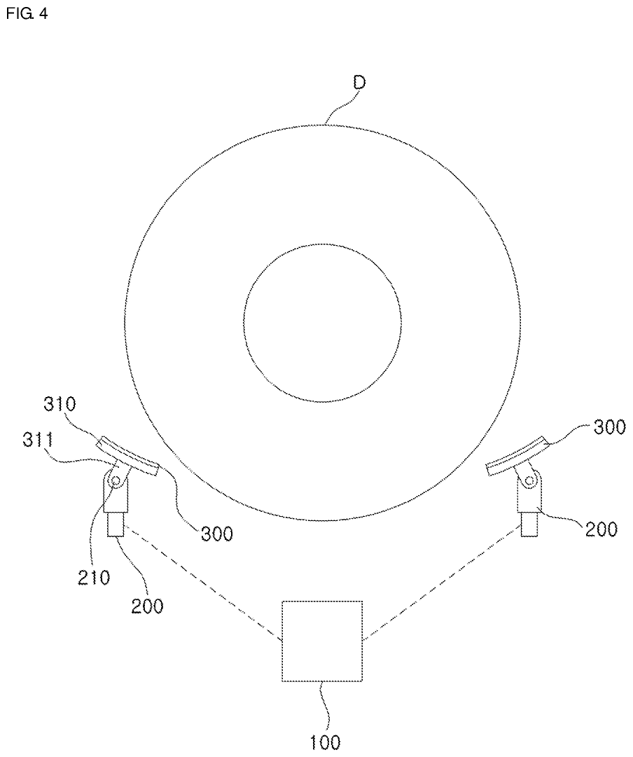

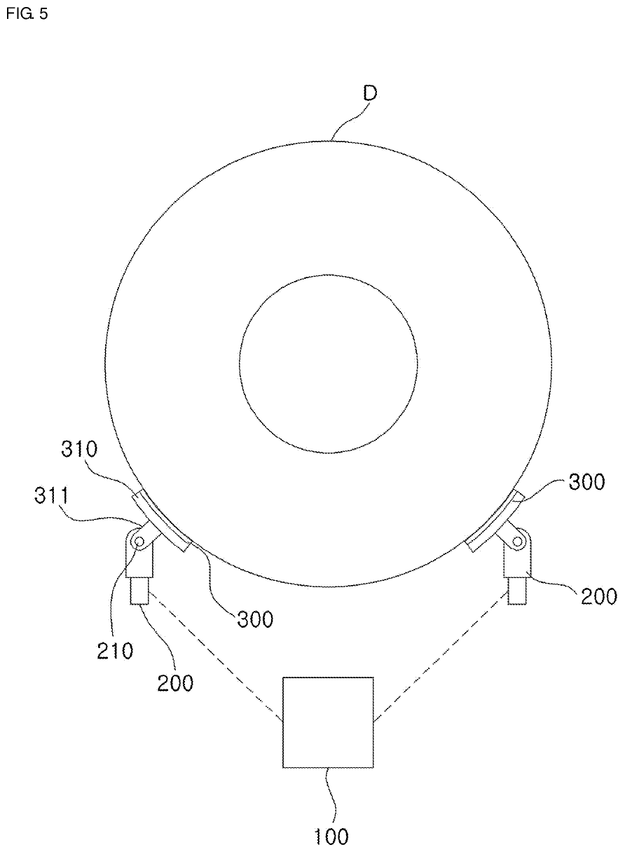

FIGS. 4 and 5 are side views, each illustrating a parking brake's disengaged state and engaged state according to another embodiment of the present disclosure.

Referring to FIGS. 4 and 5, a parking brake according to another embodiment of the present disclosure may include an actuator 100, a pair of carriers 200 disposed on both sides of an outer circumferential surface of the disk D, and a friction pad 300 arranged on the carriers 200.

The actuator 100 serves as a means to advance and retract the carriers 200, which are each disposed on both sides of the outer circumferential surface of the disk D, toward the disk D relative to a rotational axis of the disk D. As with the above embodiments, both an electromechanical method utilizing an electric motor and a hydraulic method utilizing fluid pressure can be applied. For example, the actuator 100 may include an electric motor or a hydraulic piston.

More specifically, if the actuator 100 is arranged in an electromechanical manner, the actuator 100 may further include an electric motor and a power transmission means, such as gears for converting the rotational motion output therefrom into a reciprocating motion of the carrier 200. For example, the power transmission means may be a plurality of gears that convert the rotational motion output from the actuator 100 to a closer or farther spacing between the carriers 200.

Additionally, if the actuator 100 is arranged in a hydraulic manner, the carrier 200 may be integrally arranged with a piston that is hydraulically reciprocated from a cylinder. For example, the carrier 200 may be integrally arranged with the pistons, which may be located on both sides of the cylinder and hydraulically spaced apart or reduced by the same distance.

Although not shown, the actuator 100 may be replaced by an actuator of a brake system that performs normal braking of a vehicle in which the parking brake of an embodiment of the present invention is installed. Further, the actuator 100 may be arranged to move the pair of carriers 200, each independently, toward the outer circumferential surface of the disk D.

The carriers 200 may include a rotational shaft 210 arranged on one side, and may be arranged on both sides of the outer circumferential surface of the disk D relative to a rotational axis of the disk D that rotates with the wheel of the vehicle, and may be spaced apart from each other by the actuator 100, or may be advanced and retracted toward the outer circumferential surface of the disk D independently of each other. Here, the rotational shaft 210 arranged on each carrier 200 may be arranged parallel to the rotational axis of the disk D.

The carriers 200 may also be installed with the actuator 100 on a housing or base or the like for guiding the reciprocating motion of the carriers 200, although not shown. In this case, the carrier 200 may also be installed with the actuator 100 on the housing of the brake system that performs normal braking of the vehicle in which the parking brake of an embodiment of the present disclosure is installed.

The friction pads 300 may be coupled to each of a pair of carriers 200 to be rotatable about the rotational shaft 210 to pressurize or depressurize at least a portion of the outer circumferential surface of the disk D in response to a reciprocating motion of the carriers 200. To achieve this, the friction pad 300 may include a pad plate 310 having a hinge portion 311 that rotatably engaged with the rotational shaft 210. Accordingly, the friction pad 300 can be pressed against both sides of the outer circumferential surface of the disk D to prevent rotation of the disk D, as shown in FIG. 5.

Here, the friction pad 300 may further include an elastic member 400 that provides elastic force to the friction pad 300 from the carrier 200, as in the aforementioned embodiment, and an over-rotation prevention structure that limits the rotation angle of the friction pad 300 about the rotational shaft 210.

More specifically, the elastic member 400 is fixed to the carrier 200 at one end, and the other end is fixed to one side of the friction pad 300 to provide an elastic force to allow the friction pad 300 to be rotated about the rotational shaft 210. Accordingly, the parking brake according to an embodiment of the present disclosure can maintain the friction pad 300 in a state in which the friction pad 300 is rotated to a certain angle counterclockwise about the rotational shaft 210 by the elastic member 400 when the parking brake is in a disengaged state, that is, when the vehicle is traveling or when the general brake system is in operation, as shown in FIG. 2. Furthermore, although the elastic member 400 is illustrated as a coil spring, it is understood that it may include various other elastic members known in the art.

On the other hand, in the over-rotation prevention structure, a support portion 312 arranged on the friction pad 300 may be supported on the jamming portion 200 arranged on the carrier 200 such that the friction pad 300 is prevented from rotating beyond a predetermined angle by the elastic member 400 around the rotational shaft 210. Of course, such an over-rotation prevention structure can be applied to various structures known in the art in addition to the structure described above.

Furthermore, the friction pad 300 may be provided with a relatively higher stiffness material compared to the friction pad of a brake system that performs normal braking of a vehicle, because noise and dust generated by friction between the disk and the friction pad during braking can be considered relatively less than the friction pad of a brake system that performs normal braking of a vehicle. For example, the friction pad 300 may be made of the same metal material as the disk D, such as steel.

Accordingly, the parking brake according to an embodiment of the present disclosure can improve the operational reliability of the parking brake by minimizing braking performance degradation due to frequent brake operation during operation and temperature changes caused by an external environment, etc. compared to a conventional PIC type parking brake.

In particular, the parking brake of the present embodiment can further improve the operational reliability of the parking brake by minimizing the deterioration of the braking performance due to wear or deformation of the friction pad, as described above, as the friction pad, which is provided with a relatively strong material, presses the outer circumferential surface of the disk in a radial direction to generate a braking force.

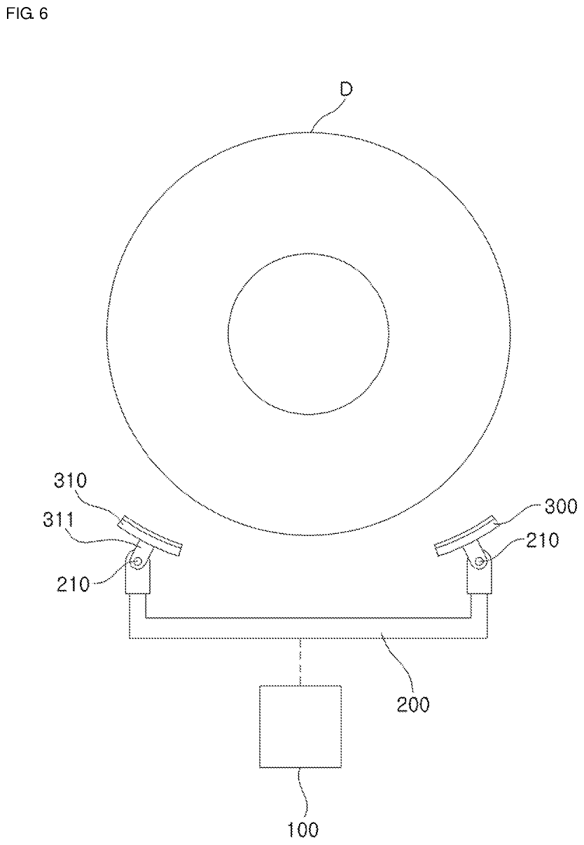

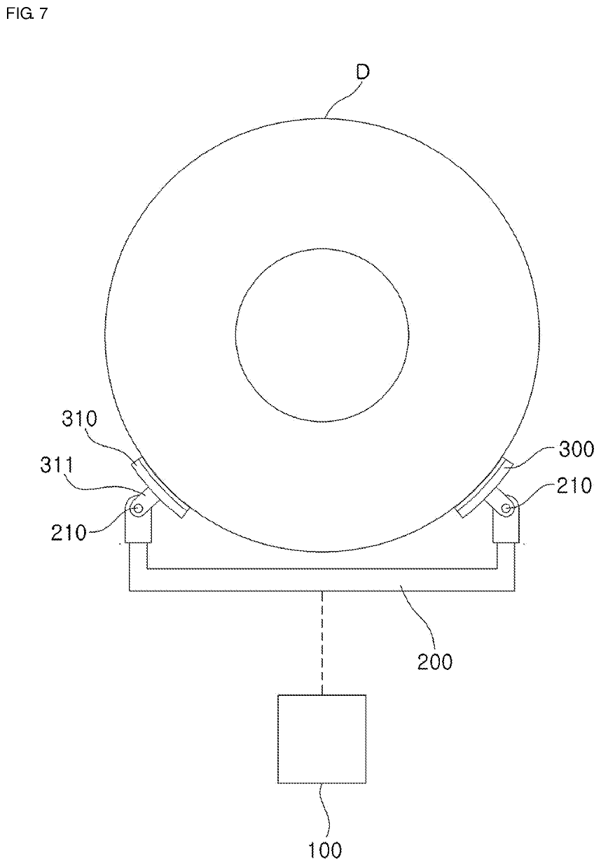

FIGS. 6 and 7 are side views, each illustrating a parking brake's disengaged state and engaged state according to yet another embodiment of the present disclosure.

Referring to FIGS. 6 and 7, a parking brake according to another embodiment of the present disclosure may include an actuator 100, a carrier 200, and friction pads 300 provided on both sides of the carrier 200.

The actuator 100 serves as a means to advance and retract the carrier 200 toward an outer circumferential surface of the disk D. As with the above embodiments, both an electromechanical method utilizing an electric motor and a hydraulic method utilizing fluid pressure can be applied. For example, the actuator 100 may include an electric motor or a hydraulic piston.

More specifically, if the actuator 100 is arranged in an electromechanical manner, the actuator 100 may further include an electric motor and a power transmission means, such as gears for converting the rotational motion output therefrom into a reciprocating motion of the carrier 200. Additionally, if the actuator 100 is arranged in a hydraulic manner, the carrier 200 may be integrally arranged with a piston that is hydraulically reciprocated from a cylinder. For example, the carrier 200 may be symmetrically branched from the piston hydraulically reciprocating from the cylinder about a rotational axis of the disk D.

Additionally, although not shown, the actuator 100 may be replaced by an actuator of a brake system that performs normal braking of a vehicle in which the parking brake of an embodiment of the present disclosure is installed.

The carrier 200 may include a rotational shaft 210 symmetrically arranged on the outer circumferential side of the disk D relative to the rotational axis of the disk D, and may be advanced and retracted toward the disk D by the actuator 100. Here, the rotational shafts 210 located on both sides of the outer circumferential surface of the disk D relative to the rotational axis of the disk D may be arranged parallel to the rotational axis of the disk D, respectively.

On the other hand, the carrier 200 may be installed with the actuator 100 on a housing or base or the like for guiding the reciprocating motion of the carrier 200, although not shown. In this case, the carrier 200 may also be installed with the actuator 100 on the housing of the brake system that performs normal braking of the vehicle in which the parking brake of an embodiment of the present disclosure is installed.

Friction pads 300 may be coupled to each of a pair of carriers 200 to be rotatable about the rotational shaft 210 to pressurize or depressurize at least a portion of the outer circumferential surface of the disk D in response to a reciprocating motion of the carriers 200. To achieve this, the friction pad 300 may include a pad plate 310 having a hinge portion 311 that rotatably engaged with the rotational shaft 210. Accordingly, the friction pad 300 can be pressed against both sides of the outer circumferential surface of the disk D to prevent rotation of the disk D, as shown in FIG. 7.

Here, the friction pad 300 may further include an elastic member 400 that provides elastic force to the friction pad 300 from the carrier 200, as in the aforementioned embodiment, and an over-rotation prevention structure that limits the rotation angle of the friction pad 300 about the rotational shaft 210.

More specifically, the elastic member 400 is fixed to the carrier 200 at one end, and the other end is fixed to one side of the friction pad 300 to provide an elastic force to allow the friction pad 300 to rotate about the rotational shaft 210. Accordingly, the parking brake according to an embodiment of the present disclosure can maintain the friction pad 300 in a state in which the friction pad 300 is rotated to a certain angle counterclockwise about the rotational shaft 210 by the elastic member 400 when the parking brake is in a disengaged state, that is, when the vehicle is traveling or when the general brake system is in operation, as shown in FIG. 2. Furthermore, although the elastic member 400 is illustrated as a coil spring, it is understood that it may include a various other elastic members known in the art.

On the other hand, in the over-rotation prevention structure, a support portion 312 arranged on the friction pad 300 may be supported on the jamming portion 200 arranged on the carrier 200 such that the friction pad 300 is prevented from rotating beyond a predetermined angle by the elastic member 400 around the rotational shaft 210. Of course, such an over-rotation prevention structure can be applied to various structures known in the art in addition to the structure described above.

Furthermore, the friction pad 300 may be provided with a relatively higher stiffness material compared to the friction pad of a brake system that performs normal braking of a vehicle, because noise and dust generated by friction between the disk and the friction pad during braking can be considered relatively less than the friction pad of a brake system that performs normal braking of a vehicle. For example, the friction pad 300 may be made of the same metal material as the disk D, such as steel.

Accordingly, the parking brake according to an embodiment of the present disclosure can improve the operational reliability of the parking brake by minimizing braking performance degradation due to frequent brake operation during operation and temperature changes caused by an external environment, etc. compared to a conventional PIC type parking brake.

In particular, the parking brake of the present embodiment can further improve the operational reliability of the parking brake by minimizing the deterioration of the braking performance due to wear or deformation of the friction pad, as described above, as the friction pad, which is provided with a relatively strong material, presses the outer circumferential surface of the disc in a radial direction to generate a braking force.

Meanwhile, exemplary embodiments about the parking brake of the present invention have been described herein, but the present disclosure is not limited thereto, and it will be apparent to those skilled in the art that various modifications can be made to the above-described exemplary embodiments of the present invention without departing from the spirit or scope of the invention.

Thus, the scope of the invention should not be limited to the described embodiments, but should be defined by the scope of the appended claims and their equivalents.

In other words, the foregoing embodiments are to be understood as exemplary and not limiting in all respects, and the scope of the invention is to be indicated by the claims of the patent application to be described hereinafter rather than by their detailed description, and the meaning and scope of the claims of the patent application and all modifications or variations derived from the concept of equivalents are to be construed as being included in the scope of the invention.

What is claimed is:

1. A parking brake comprising:
a disk configured to rotate with a wheel of a vehicle;
a carrier having a rotational shaft formed at one side, configured to advance and retract by an actuator toward an outer circumferential surface of the disk; and
a friction pad coupled to the carrier to be rotatable about the rotational shaft, configured to pressurize or depressurize at least a portion of the outer circumferential surface of the disk in response to reciprocating motion of the carrier.

2. The parking brake of claim 1, wherein the friction pad includes:
a pad plate having a hinge portion rotatably engaged with the rotational shaft; and
a friction surface arranged between the pad plate and the outer circumferential surface of the disk.

3. The parking brake of claim 2, wherein the friction surface is arranged in an arc shape having a curvature equal to a curvature of the disk.

4. The parking brake of claim 1, wherein the rotational shaft is arranged parallel to a rotational axis of the disk.

5. The parking brake of claim 1, further comprising an elastic member between the carrier and the friction pad, configured to provide an elastic force to allow the friction pad to be rotated about the rotational shaft.

6. The parking brake of claim 5, wherein the elastic member is coupled to the carrier at one end and to the friction pad at the other end to rotate the friction pad to a predetermined angle about the rotational shaft when the carrier is spaced from the disk.

7. The parking brake of claim 6, wherein the rotation angle of the friction pad rotating about the rotational shaft by the elastic member is limited by a jamming portion arranged on the carrier and a support portion arranged on the friction pad.

8. The parking brake of claim 6, wherein the friction pad further includes a rounding portion arranged at an end where the carrier is moved toward the outer circumferential surface of the disk and makes first contact with the outer circumferential surface of the disk.

9. A parking brake comprising:
a disk configured to rotate with a wheel of a vehicle;
a pair of carriers each having a rotational shaft arranged on one side and disposed on both sides of an outer circumferential surface of the disk relative to a rotational axis of the disk, configured to advance and retract by an actuator toward the outer circumferential surface of the disk; and
a pair of friction pads each coupled to the carrier to be rotatable about the rotational shaft, configured to pressurize or depressurize at least a portion of the outer circumferential surface of the disk in response to reciprocating motion of the carrier.

10. The parking brake of claim 9, wherein the friction pad includes:
a pad plate having a hinge portion rotatably engaged with the rotational shaft; and
a friction surface arranged between the pad plate and the outer circumferential surface of the disk.

11. The parking brake of claim 10, wherein the friction surface is arranged in an arc shape having a curvature equal to a curvature of the disk.

12. The parking brake of claim 9, wherein the rotational shaft is arranged parallel to a rotational axis of the disk.

13. The parking brake of claim 9, wherein the carriers are arranged to be spaced from each other relative to a rotational axis of the disk by the actuator.

14. The parking brake of claim 9, wherein the carriers are arranged to be advanced and retracted by the actuator independently of each other toward the outer circumferential surface of the disk.

15. A parking brake comprising:
a disk configured to rotate with a wheel of a vehicle;
a carrier having a rotational shaft arranged on each side of the carrier, configured to advance and retract by an actuator toward an outer circumferential surface of the disk; and
a pair of friction pads each coupled to both sides of the carrier to be rotatable about each rotational shaft, configured to pressurize or depressurize at least a portion of the outer circumferential surface of the disk in response to reciprocating motion of the carrier.

16. The parking brake of claim 15, wherein a center between the rotational shafts is arranged on a straight line equal to a center of a rotational axis of the disk.

17. The parking brake of claim 15, wherein the friction pad includes:
a pad plate having a hinge portion rotatably engaged with the rotational shaft; and
a friction surface arranged between the pad plate and the outer circumferential surface of the disk.

18. The parking brake of claim 16, wherein the friction surface is arranged in an arc shape having a curvature equal to a curvature of the disk.

19. The parking brake of claim 15, wherein the rotational shaft is arranged parallel to a rotational axis of the disk.

20. The parking brake of claim 15, wherein the friction pad further includes a rounding portion arranged at an end where the carrier is moved toward the outer circumferential surface of the disk and makes first contact with the outer circumferential surface of the disk.
